(19) United States
(12) Patent Application Publication
(10) Pub. No.: US 2004/0102573 A1
(43) Pub. Date: May 27, 2004

(54) Material made from a polyurethane gel

(76) Inventors: Adolf Stender, Duderstadt (DE); Hermann Benkhoff, Duderstadt (DE)

Correspondence Address: HUSCH & EPPENBERGER, LLC, 401 MAIN STREET, SUITE 1400, PEORIA, IL, 61602, US

(21) Appl. No.: 10/656,778

(22) Filed: Sep. 5, 2003

Related U.S. Application Data
(63) Continuation-in-part of application No. 09/825,318, filed on Apr. 3, 2001, now abandoned.

(30) Foreign Application Priority Data
Apr. 3, 2000 (DE) 100 16 539.7

(51) Int. Cl. C08L 75/00

(52) U.S. Cl. 525/123

(57) ABSTRACT

A polyurethane gel filled with an expanded calcium carbonate offers an improved material for various applications, wherein the advantageous gel properties are retained, but at the same time negative properties, such as relatively high specific weight and high thermal conductivity, are avoided.

### CROSS-REFERENCE TO RELATED APPLICATIONS

This application is a continuation-in-part of application Ser. No. 09/825,318 filed Apr. 3, 2001, now ______.

### BACKGROUND OF THE INVENTION

The present invention relates generally to polyurethane gels and more particularly to a material made from a polyurethane gel and a process for its production.

Polyurethane gels, that is undercured reaction products based on polyols and polyisocyanates, are generally known per se. Known undercured reaction products are used, for example, as pressure-distributing elements in upholstery for wheel-chairs, as shown in Patent EP 511 570 or for bicycle saddles, as shown in U.S. Pat. No. 5,330,249.

Patent EP 57 838 claims gels for avoiding decubitus which are characterized by undercuring. These gels are produced by reacting a polyisocyanate with long-chain polyols, which should be free of short-chain portions. These dimensionally stable gels, made from polyurethane raw materials may, be used as mattresses, mattress fillings, car seats and upholstery material. Patent EP 511 570 discloses improved undercured gels made from polyols and polyisocyanates, which are produced from mixtures of long-chain and short-chain polyethers. The polyol and polyisocyanate mixtures to be produced more favorably in terms of processing technology are preferably used as padding material in the shoe industry, as pads for avoiding or preventing injuries, face masks, as padding for horse saddles and in various other applications.

Known polyol and polyisocyanate mixtures have the disadvantage of high dead weight and high thermal capacity. As a result of the high dead weight of about 1.0 g/cm³, use is restricted to the limited number of applications in which the disadvantages of the additional weight do not outweigh the desirable pressure-distributing properties. Furthermore, the high thermal capacity of the polyurethane gel may be perceived as unpleasant in direct body contact, since body heat is clearly and perceptibly removed from the body to heat the particular gel compositions.

Patent German Offenlegungsschrift 4 308 445 mentions various processes or patent specifications (European granted patent 0 057 839; World application 88/01878; European 0 453 286) for producing gel foams using air, nitrogen and carbon dioxide. The reduction in specific weight and the reduction in the thermal capacity associated therewith are achieved to the required extent, however, the gels have the disadvantage that the cells formed adhere during pressure stress at the inner walls of the cells due to the very high self-adhesive behavior of undercured reaction products based on polyols and polyisocyanates. Furthermore, the cells represent a weakening of the gel matrix, which has a negative effect on mechanical properties such as extension at break and tensile strength. Furthermore, a cellular gel reverts more slowly to its starting position after loading, which is an undesirable characteristic. Also, shrinkage problems may occur with cellular gels, as are known from processing polyurethane foams.

U.S. Pat. No. 5,350,778 to Steppan et al. discloses polyurethane materials having rigid microspheres as a filler. Steppan further instructs that these microspheres should be heat resistant and incompressible. See col. 9, lines 14-16. In other words, they should be rigid. While Steppan does admit the possibility of using elastic microspheres as a filler, Steppan expressly disavows their utility. See col. 10, lines 16-17; see also col. 11, lines 20-22.

The present invention clearly is a technical improvement over the prior art in that it comprises a gel composition, which has considerably reduced lower weight and thermal capacity, yet retains the typical, desirable gel properties, such as the absorption of shearing forces.

The present invention is directed to overcoming one or more of the problems set forth above.

### SUMMARY OF THE INVENTION

An aspect of the invention therefore consists in developing a material which avoids the above-mentioned disadvantages and combines the typical advantageous gel properties with a low specific weight and an overall lower thermal conductivity, as well as good durability and permanently consistent functional properties.

The above aspect is achieved according to the invention in that the material made from a polyurethane gel contains elastic microspheres as filler. The elastic microspheres of the present invention considerably reduce both the specific weight and the specific thermal conductivity of the material overall. In contrast to the cells of a foam, the microspheres within the polyurethane gel are permanently stable, so that the advantageous functional properties achieved are retained over the entire lifetime of the product. The elastic microspheres preferably include either a polymer material or a polyolefin, such as acrylonitrile copolymer or polyvinylidene chloride.

In another embodiment of the invention, the microspheres consist of expanded polymer materials, preferably expanded polyolefins.

It is advantageous if the elastic microspheres are coated with a cover layer of an inorganic material, preferably calcium carbonate. The inorganic coating should prevent agglomeration of the microspheres within the gel. Calcium carbonate is preferably used as the inorganic material, although other inorganic materials, in particular inorganic salts, are possible. In the applied sense, this embodiment of the elastic microspheres is high-volume expanded calcium carbonate.

The elastic microspheres incorporated into the material preferably have a diameter of 10 μm to 150 μm. The proportion of microspheres in the material is preferably between about 0.1 wt. % to 10 wt. %. Generally, the proportion of microspheres is freely selectable depending on the gel selected and is subject only to the condition that a stable material having the required properties is to be produced.

An undercured polyurethane based on polyols and polyisocyanates or polyethers and polyisocyanates is preferably used for the gel. The gel compositions may thus be produced using raw materials of isocyanate functionality of the polyol component of at least 5.2, preferably of at least 6.5, in particular of at least 7.5.

These aspects of the invention are merely illustrative of the innumerable aspects associated with the present invention and should not be construed as limiting in any manner.

The above and other aspects, features and advantages of the present invention will become apparent from the following detailed description when taken in conjunction with the accompanying drawings.

### DETAILED DESCRIPTION

According to a preferred embodiment, the polyol component for producing the gel consists of a) a mixture of one or more polyols having hydroxyl numbers below 112, and b) one or more polyols having hydroxyl numbers in the range from 112 to 116. The weight ratio of component a) to component b) lies between 90:10 and 10:90. Also, the isocyanate index of the reaction mixture lies in the range 15 to about 60 and the product of isocyanate functionality and functionality of the polyol component is at least 6.15.

According to another preferred embodiment, the polyol component for producing the gel consists of one or more polyols having a molecular weight between 1,000 and 12,000 and an OH number between 20 and 112, wherein the product of the functionalities of the polyurethane-forming components is at least 5.2 and the isocyanate index lies between 15 and 60. Furthermore, as isocyanates for gel production, those of the formula Q(NCO)ₙ may preferably be used, where n represents 2 to 4 and Q denotes an aliphatic hydrocarbon radical having 8 to 18 carbon atoms, a cycloaliphatic hydrocarbon radical having 4 to 15 carbon atoms, an aromatic hydrocarbon radical having 6 to 15 carbon atoms or an araliphatic hydrocarbon radical having 8 to 15 carbon atoms.

The isocyanates may be used in pure form or in the form of conventional isocyanate modifications, as are known to the experts in this field. Suitable modifications of the isocyanate component include urethanisation, allophanisation or biurethisation.

To achieve a previously stated aspect, a special process for producing the material from the polyurethane gel and the microspheres is also provided according to the invention, which is characterized in that elastic microspheres are incorporated as filler into the polyurethane gel during its production while largely avoiding air or gas introduction.

The microspheres of the preferred embodiments are preferably incorporated into the polyol component. Processing with the microspheres in the isocyanate is likewise possible. Incorporation of the microspheres must be carried out so that no additional air is also incorporated into the polyol or isocyanate. The air bubbles would cause the undesirable the negative properties that are commonly found in the gels that are known in the art. In particular, the tear-propagation strength would be considerably reduced because the air bubbles act as theoretical break points.

The microspheres are preferably formed from a polymer material, in particular a polyolefin, such as an acrylonitrile copolymer or polyvinylidene chloride, and are coated with an inorganic material, preferably calcium carbonate, before their processing. The microspheres are advantageously mixed into at least one initially placed component for polyurethane formation, while supplying high shearing energy using a high-speed mixer or with the aid of a dissolver.

Incorporation of the microspheres should be carried out so that a high degree of wetting the individual particles is guaranteed and so that introduction of air or gas is avoided as much as possible. To that end, processes for incorporating pulverulent products under vacuum are preferred. Two methods in particular are mentioned here specifically.

In the first process, polyol or isocyanate is situated in the mixing chamber of a high-speed mixer under vacuum (Messrs. Grieser, Maschinenbau-und Service GmbH, Chemiestraβe 19, Lampertheim). The microspheres coated with CaCO₃ are drawn in below the liquid level via the vacuum applied in the mixing chamber. Care should be taken to ensure that the particles of the invention are drawn in directly in the region of maximum angular speed of the stirrer operating at a high speed. The high shearing energy leads to homogeneous dispersion. The air drawn in by this process is removed from the mixture by the vacuum along with the action of constant stirring.

In the second tested process, the reaction component to be enriched with the microspheres is situated in an open tank and is pumped around by means of a dissolver. Negative pressure, with which the pulverulent particles are drawn into the reaction component, is produced in the dissolver disc (Messrs. YSTRAL, Ballrechten-Dottingen). Maximum wetting with correspondingly low air charging is thus guaranteed. The incorporated air is removed by applying a vacuum while stirring the reaction component treated with microspheres. The stirring mechanism is switched on or off at three-minute intervals. The rising air additionally collects below the blade surfaces due to the slow rotation of the blade mixer, so that larger air bubbles are formed. When the mixer is at a standstill, the large air bubbles rise in an accelerated manner, which considerably accelerates their evacuation.

The reaction component charged with the microspheres is advantageously added to the daily service tank of a 2 K machine for further processing. To avoid separation of the specifically light hollow spheres, the dispersion of the invention is preferably continuously circulated.

### A. EXAMPLES

The following gel plates having separating agents applied to both sides were produced according to the processes described above using the isocyanate and polyol raw materials described in European patent EP 57 838 and EP 511 570.

In the examples below, the microspheres were incorporated into the polyol component. The polyol composition flow required is pumped via a precision pump to a metering gun with a downstream dynamic mixer. The isocyanate component necessary for polyaddition is also passed to the dynamic mixer by means of a separate high-precision pump and mixed homogeneously with the polyol component. Care should be taken in particular to ensure that the two components are mixed homogeneously, to ensure that the properties of the end product are uniform. The two homogeneously prepared components may be cast into a molding die, such as for example plates. The polyaddition reaction is accelerated by additional heating of the dies.

Component A is a trifunctional polyether polyol of OH number 28. It is produced by propoxylation of trimethylolpropane with subsequent ethoxylation (PO/EO=83/17). In addition, component A contains 0.1 wt. % of Coscat 83 (commercial product of Cosan Chemical Co.).

Component B is a modified aliphatic isocyanate from Bayer AG: Desmodur KA 8712.

### Example 1

Thickness 3.0 mm

Mixing ratio: 100:13 (component A:component B)

Component A: 97 parts by weight polyol+3 parts by weight highly elastic microspheres

(Dualite M 6001 AE, Lehmann & Voss & Co., Hamburg)

Component B: Isocyanate

### Example 2

Thickness: 3.0 mm

Mixing ratio: 100:13 (component A:component B)

Component A: 97 parts by weight polyol+3 parts by weight highly elastic microspheres

(Dualite MS 7000, Lehmann & Voss & Co., Hamburg)

Component B: Isocyanate

### Comparative Example 1

Thickness: 3.0 mm

Mixing ratio: 100:13 (component A:component B)

Component A: 100 parts by weight polyol

Component B: Isocyanate

TABLE 1

| | Bulk density | Tensile strength | Extension at break |
|---|---|---|---|
| | [kg/m³] | [Kpa] | [%] |
| | DIN 53 420 | DIN 53 571 | DIN 53 571 |
| Example 1 | 864 | 892 | 335 |
| Example 2 | 756 | 767 | 388 |
| Comparative | 1059 | 455 | 343 |
| example 1 | | | |

The thermal conductivity was considerably reduced by the addition of highly elastic microspheres, which was detected by direct body contact. Test people could differentiate the plates produced using hollow spheres from the conventional gel plates with blindfolded eyes. According to a unified statement of all test people, the plates produced using hollow spheres were assessed as “warmer”. This can be explained by the lower thermal conductivity of the plates produced using the hollow spheres.

### B. Examples and Comparative Examples Designed to Show the Advantages in Elasticity

Description of the Preparation:

The following raw materials were used for the preparation of the examples and comparative examples:

Polyol: A polyol mixture consisting of Baycoll BD 4028 having an OH number of 29.0+/−1.5% and Levagel SN 100 based on a PO/EO polyetherpolyol having an OH number of 35+/−2.5%, determined by test method 2201-021101-90-D (manufacturer: BAYER, Leverkusen), which contains an activator Coscat C83 based on an organic bismuth compound (supplier: Erbsloh, Krefeld), is prepared as a basic batch by homogeneously mixing the polyols in equal parts with one another by a technique customary in polyol technology.

Isocyanate: An aliphatic isocyanate, Desmodur E 305 (manufacturer: BAYER, Leverkusen), based on HDI and having an NCO content of 11.3%, is used as a reactant.

Processing assistants: The additive Byk 410 and Byk 966 (manufacture: Byk Chemie, Wesel) are added homogeneously as processing assistants to the polyol mixture in a concentration of from 0.3 to 5%, preferably from 0.5 to 2%, based on the fillers (hollow microspheres).

Hollow microspheres: Expanded hollow microspheres coated with CaCO₃, Dualite MS 7000 (supplier: Lehmann & Voss & Co. Hamburg) are used as a filler in a concentration of from 0.5 to 20%, preferably from 3 to 10%, based on the polyol mixture.

Incorporation Methods for Hollow Microspheres:

The polyol mixture containing the activator and the processing assistant are homogeneously mixed with one another in a vessel by means of commercial stirrers. After the mixture has been sufficiently stirred, the hollow microspheres are added to the polyol mixture with constant stirring. When the pulverulent hollow microspheres have been taken up by the mixture, this material is stirred for about a further 20 minutes. The preparation process is followed by a brief evacuation, only a minimum reduced pressure being permitted.

Formulation of the Polyol Mixture:

9.25 parts by weight of BD Baycoll BD 4028

9.25 parts by weight of Levagel SN 100

1.5 parts by weight of Dualite MS 7000

0.004 part by weight of Byk 410

0.004 part by weight of Byk 966

0.004 part by weight of Coscat 83

total: 20.012 parts by weight;

mixed with isocyanate according to the table below;

content of hollow microspheres: 6.7 to 6.8 wt %

Molds Used:

For the preparation of the examples and comparative examples 3 and 4, a wooden box with a vacuum connection was used. The side of the box opposite the connection side was provided with drilled holes having a diameter of about 1.5 mm, uniformly over the entire surface (grid dimensions: about 5×5 cm). The drilled side of the box was covered with an open-pore textile so that a vacuum over the whole area was generated. Wood strips were placed on the textile, corresponding to the pattern dimensions. As an alternative to the woods strips, prefabricated frames of wood or metal can also be used.

Thermoforming of the Film:

A commercial PU film (manufacturer e.g. Epurex, Walsrode) was placed over the wood strips and fixed at the edge by means of a commercial adhesive tape. The stretched PU film was heated uniformly by means of a ceramic radiator and then drawn by means of a vacuum into the indentation produced by means of wood or metal frames. The thermoforming temperature to be established should be determined empirically. After the mixture consisting of polyol, isocyanate, activator and processing assistants with or without hollow microspheres has been introduced into the mold cavity, a PU film rolled up on a cylinder is manually laminated with the mixture which is still not completely reacted.

Processing of the Raw Materials:

The polyol mixture and the isocyanate are introduced into separate pressure-resistant containers and pumped in a mixing ratio of from 100:10 to 14, preferably 10 to 12.5, by means of gear pumps through a downstream mixer. The mixer screw is rotated by means of an air motor for better homogenization of the isocyanate and polyol components. The material is introduced in the liquid state into the mold lined with the PU film. When the mold has been appropriately filled, a closing PU film is laminated with the polyol/isocyanate mixture which still has not undergone partial reaction. After the material has completely reacted, the moldings are trimmed by means of scissors. The mixing ratio to be established is dependent on the desired hardness of the end product, which has to be found empirically by measuring the hardness. Examples and respective comparative examples 3 and 4 are adjusted to (approximately) the same Shore hardness L.

Measurement of the Product Properties:

The samples are stored at room temperature for about 48 hours before the measurements can be started.

Gross Density

The gross density is determined by calculating the volume of the test specimen geometry with the density 1 kg/m³. The weight of the sample of the example or comparative example is accordingly determined and expressed as a ratio.

Tensile Strength and Elongation at Break

The tensile strength and elongation at break were determined in compliance with standard DIN 53571, titled “Testing Of Flexible Cellular Materials; Tensile Strength Testing; Determination Of Tensile Strength And Elongation At Break.”

Shore Hardness L

The samples of the example and comparative example are placed on a smooth, hard surface. A Shore hardness measuring instrument, a densimeter (L), is placed on the flat side of the test specimen. The hardness is read after about 3 seconds.

Resilience and Loss Factor

The resilience and loss factor were determined in compliance with standard DIN 53426.

TABLE 2

| | | Comparative | | Comparative |
|---|---|---|---|---|
| | Example 3 | example 3 | Example 4 | example 4 |
| Mixing ratio | 100:10 | 100:11 | 100:11.5 | 100:12.5 |
| polyol: | | | | |
| isocyanate | | | | |
| Gross density | 868 | 1134 | 818 | 1110 |
| [kg/m³] | | | | |
| Tensile | 678 | 593 | 862 | 777 |
| strength | | | | |
| [kPa] | | | | |
| Elongation at | 511 | 483 | 508 | 511 |
| break (%) | | | | |
| Shore | 28 | 26 | 38 | 40 |
| hardness L | | | | |
| Resilience | 21 | 15 | 28 | 26 |
| (%) | | | | |
| Loss factor | 0.64 | 0.81 | 0.54 | 0.69 |
| (analogous to | | | | |
| DIN 53426) | | | | |

The mixing ratios in the examples and the comparative examples 3 and 4 were chosen so that the Shore hardness achieved are about the same in each case; i.e. ±2. Inevitably, the gross densities in the examples were lower than in the comparative examples. Table 2 shows that the gel material with elastic microspheres has an improved elasticity although the Shore hardness remains essentially the same.

The higher resilience of the lighter gel means a considerable advantage. The resilience can be adjusted within certain limits without resulting in changes in the hardness. For example, an increase in the isocyanate content usually leads to more elastic gels. Unfortunately, however, an increase in the hardness is always observed thereby.

The improved elasticity achieved by the invention is evident from the better resilience and from the lower loss factor.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the materials and methods herein described and illustrated without departing from the scope of the invention, it is intended that all matter contained in the foregoing description be interpreted as illustrative rather than limiting. Thus, the breadth and scope of the present invention should not be limited by any of the above-described exemplary embodiments, but should be defined only in accordance with the following claims appended hereto and their equivalents.

We claim:

1. A material comprising:
a polyurethane gel that includes an undercured reaction product of polyols and polyisocyanates, and having elastic microspheres as filler.

2. The material according to claim 1, wherein the elastic microspheres includes polymer material.

3. The material according to claim 2, wherein the polymer material includes polyolefin.

4. The material according to claim 2, wherein the polymer material includes expanded polymer material.

5. The material according to claim 1, wherein the elastic microspheres have a cover layer coating that includes an inorganic material.

6. The material according to claim 5, wherein the inorganic material includes calcium carbonate.

7. The material according to claim 1, wherein the elastic microspheres have a diameter in a range of 10 μm to 150 μm.

8. The material according to claim 1, wherein the percentage of elastic microspheres in the material is from 0.1% to 10% of total material weight.

9. The material according to claim 1, wherein the polyol component of the polyurethane gel has an isocyanate functionality of at least 5.2.

10. The material according to claim 1, wherein the polyol component of the polyurethane gel has an isocyanate functionality of at least 6.5.

11. The material according to claim 1, wherein the polyol component of the polyurethane gel has an isocyanate functionality of at least 7.5.

12. The material according to claim 1, wherein the polyol component of the polyurethane gel includes a mixture of:
a first component that includes one or more polyols having hydroxyl numbers below 112 and second component that includes one or more polyols having hydroxyl numbers in the range from 112 to 600, wherein a weight ratio of the first component to the second component is in a range from 90:10 to 10:90, an isocyanate index of a reaction mixture of the first component and the second component lies in a range from 15 to 60 and a product of isocyanate functionality and functionality of the polyol component is at least 6.

13. The material according to claim 1, wherein the polyol component of the polyurethane gel includes one or more polyols having a molecular weight in a range between 1,000 and 12,000 and an OH number in a range between 20 and 112 and a product of isocyanate functionality and functionality of the one or more polyols is at least 5 and an isocyanate index is in a range between 15 and 60.

14. The material according to claim 1, further including isocyanates utilized in producing the polyurethane gel, wherein the isocyanates are of a formula Q(NCO)n, in which n represents 2 to 4 and Q selected from the group consisting of an aliphatic hydrocarbon radical having 8 to 18 C atoms, a cycloaliphatic hydrocarbon radical having 4 to 15 C atoms, an aromatic hydrocarbon radical having 6 to 15 C atoms and an araliphatic hydrocarbon radical having 8 to 15 C atoms.

15. The material according to claim 1, wherein the polyurethane gel includes pure form isocyanates utilized in production of the polyurethane gel.

16. The material according to claim 1, wherein the polyurethane gel includes modified isocyanates utilized in production of the polyurethane gel.

17. The material according to claim 1, wherein the polyurethane gel includes urethanised isocyanates utilized in production of the polyurethane gel.

18. The material according to claim 1, wherein the polyurethane gel includes allophanised isocyanates utilized in production of the polyurethane gel.

19. The material according to claim 1, wherein the polyurethane gel includes biurethised isocyanates utilized in production of the polyurethane gel.

20. A material having improved elasticity and comprising:
a polyurethane gel that includes an undercured reaction product of polyols and polyisocyanates, and having elastic microspheres as filler, wherein the percentage of elastic microspheres in the material is from about 3% to about 10% total material weight and the elastic microspheres have a cover layer coating of calcium carbonate, and whereby the resulting material has about the same Shore hardness as the polyurethane gel without filler but has greater elasticity than the polyurethane gel without filler.
